(19) United States
(12) Patent Application Publication
(10) Pub. No.: US 2007/0278043 A1
(43) Pub. Date: Dec. 6, 2007

(54) SYSTEM AND DEVICE FOR DESCENDING STAIRS

(76) Inventor: Stephen P. Durant, Altamont, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/383,289

(22) Filed: May 15, 2006

(51) Int. Cl. B66B 9/08

(52) U.S. Cl. 187/201; 187/202

(57) ABSTRACT

The present invention provides a system and device for descending stairs. In one embodiment, the invention provides a system for transporting an individual down a flight of stairs, including means for directing at least one seat member selected from a group consisting of: a track adapted to accept at least one wheeled member of the at least one seat member and a cable adapted to support a clamp member secured to the at least one seat member.

### BACKGROUND OF THE INVENTION

1. Technical Field

The invention relates generally to devices for descending stairs, and more particularly, to a gravity-powered system and device for transporting a disabled individual down a flight of stairs.

2. Background Art

In the event of an emergency, it is often necessary to evacuate residential and commercial buildings. Often, such buildings comprise more than one story or level. Due to the nature of an emergency evacuation (e.g., fire, power loss, etc.), it is inadvisable for an individual to use an elevator in making his or her evacuation. As such, the only other evacuation routes typically available include stairways and/or stairwells.

Physically disabled individuals, whether previously disabled or injured as a result of the emergency prompting the evacuation, are often unable to utilize stairways or stairwells in making their evacuation. As a consequence, such individuals must either be aided in their descent of the stairway or stairwell by a non-disabled individual or await assistance from rescue personnel. This is problematic, as it jeopardizes not only the disabled individual but those aiding their evacuation and those hindered from making their own evacuations.

A number of systems and devices have been proposed for the transportation of disabled individuals in emergency situations. For example, U.S. Pat. No. 5,539,945 to Rosenberg et al. discloses a stretcher device that can be supported at one end by a cable secured to a stairwell. However, the occupant of the stretcher must be secured in the stretcher by a rescuer and then carried down the stairway by at least one such rescuer.

U.S. Pat. No. 4,963,762 to Brooks discloses an evacuation chair comprising a seat supported by two elongated poles, each pole having a handle on each end. An individual may thereby by carried down a flight of stairs by a pair of rescuers, each holding an end of each of the two poles. Thus, transportation of the individual requires the aid of at least two rescuers. U.S. Pat. No. 5,466,040 to Fainsztein describes a device similar to that of Brooks, wherein the ends of the poles are supported by a harness worn by each of the rescuers, thereby keeping the hands of the rescuers free.

While each of the devices above enables the evacuation of a disabled individual with greater ease than merely carrying the individual down a flight of stairs, each is similarly unsatisfactory because of their reliance on the aid of at least one rescuer; often at least two rescuers.

To this extent, a need exists for a system and device for descending stairs that do not suffer from the defects of known systems and devices.

### SUMMARY OF THE INVENTION

The present invention provides a system and device for descending stairs. In one embodiment, the invention provides a system for transporting an individual down a flight of stairs, including means for directing at least one seat member selected from a group consisting of: a track adapted to accept at least one wheeled member of the at least one seat member and a cable adapted to support a clamp member secured to the at least one seat member.

A first aspect of the invention provides a device for transporting an individual down a flight of stairs comprising: a seat member adapted to support an individual; at least one wheeled member adapted to follow a track adjacent a flight of stairs; and a brake member adapted to control a rate of descent of the device along the track.

A second aspect of the invention provides a device for transporting an individual down a flight of stairs comprising: a seat member adapted to support an individual; at least one clamp member adapted to follow a cable adjacent a flight of stairs; and a brake member adapted to control a rate of descent of the device along the track.

A third aspect of the invention provides a system for transporting an individual down a flight of stairs comprising: at least one seat member adapted to support an individual; means for directing the at least one seat member along a path adjacent a flight of stairs; and a brake member for controlling a rate of descent of the at least one seat member along the path.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1A-D show various views of an illustrative rescue chair according to the invention.

FIG. 2 shows an illustrative braking mechanism according to the invention.

FIG. 3 shows a system comprising the rescue chair of FIGS. 1A-D in conjunction with a pair of track members according to the invention.

FIGS. 4A-B show detailed views of the use of a track member of FIG. 3.

FIGS. 5A-B show an anti-collision device according to the invention.

FIGS. 6A-B show side and top cross-sectional views of a friction member for slowing a rescue chair according to the invention.

FIGS. 7A-B show an illustrative adjustable track according to the invention.

FIGS. 8A-B show an alternative system comprising the rescue chair of FIGS. 1A-D in conjunction with a cable according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

As indicated above, the invention provides a system and device for descending stairs.

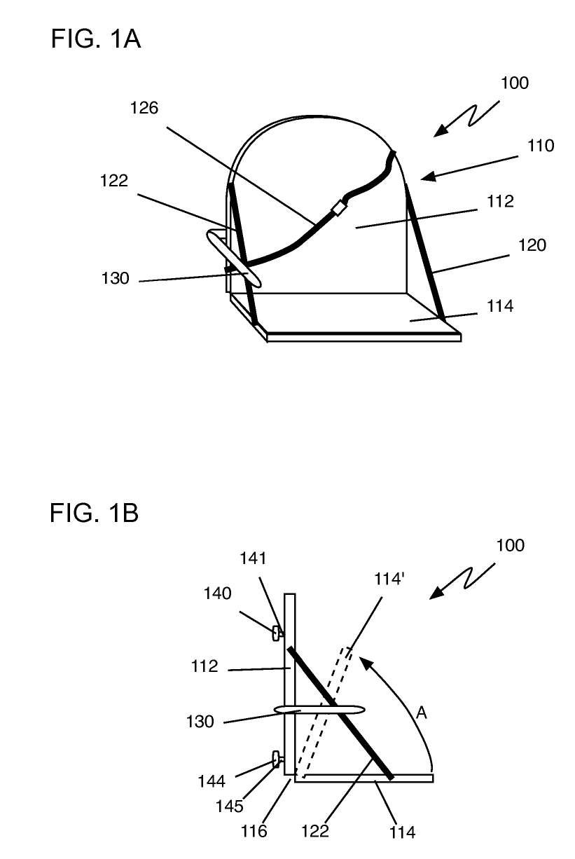

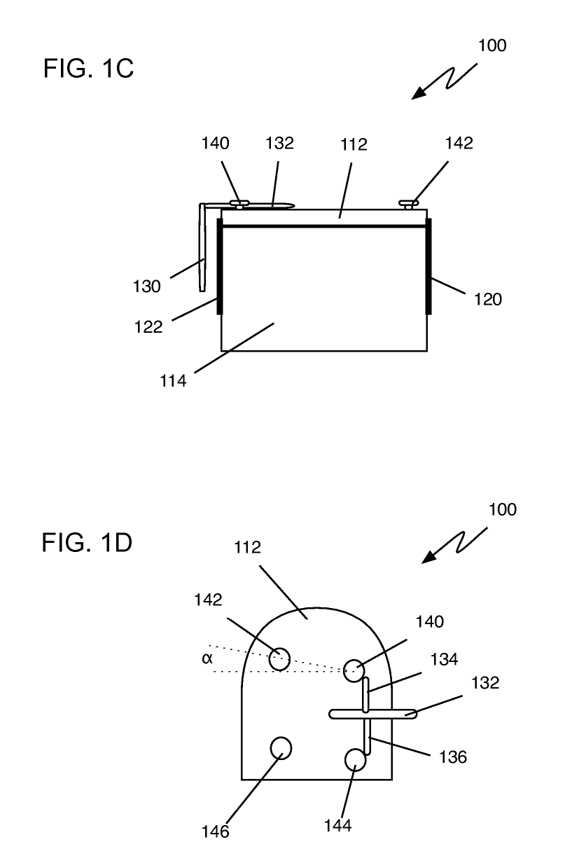

FIGS. 1A-D show various views of an illustrative rescue chair 100 according to the invention. FIG. 1A shows a front perspective view of the rescue chair 100 comprising a seat 110 having a back portion 112 and bottom portion 114, a pair of supports 120, 122 supporting the bottom portion 114 to the back portion 112, and a brake handle 130. Preferably, back portion 112 and bottom portion 114 are hingedly connected, permitting the folding of bottom portion 114 against back portion 112 when rescue chair 100 is not in use. Rescue chair 100 may further include a safety belt 126 of other device for securing a user within the chair.

FIG. 1B shows a side view of rescue chair 100 and the pivotal movement of bottom portion 114 at hinge 116 and along path A to position 114′ (shown in phantom). Also shown are wheeled members 140, 144, each secured to back portion 112 by posts 141, 145, respectively. Wheeled members 140, 144 are adapted to be inserted into a track, as will be described in greater detail below. Rescue chair 100 includes at least one wheeled member, preferably at least two wheeled members, one located vertically above the other, and more preferably four wheeled members arranged in two pairs, one pair located vertically above the other pair.

FIG. 1C shows a top view of rescue chair 100, including the location of an additional wheeled member 142. FIG. 1C also shows the connection of brake arm 130 to brake shaft 132, which will be described in greater detail below.

FIG. 1D shows a rear view of rescue chair 100. As shown in FIG. 1D, rescue chair 100 includes four wheeled members 140, 142, 144, 146 arranged in two pairs (140 and 142 being located vertically above 144 and 146, respectively). As will be described in greater detail below, at least two of the four wheeled members are adapted to be inserted into a track (not shown) secured to a railing or wall adjacent a stairway. As such, the wheeled members comprising each pair of wheeled members (i.e., 140 and 142, 144 and 146) are offset from each other at angle α in order to accommodate the pitch of the track and the stairway.

Still referring to FIG. 1D, brake shaft 132 is shown comprising a pair of brake rods 134, 136, each adapted to alternately move toward and away from wheeled members 140 and 144, respectively, preventing or impeding the movement of wheeled members 140, 144 along the track, thereby stopping or slowing the descent of rescue chair 100.

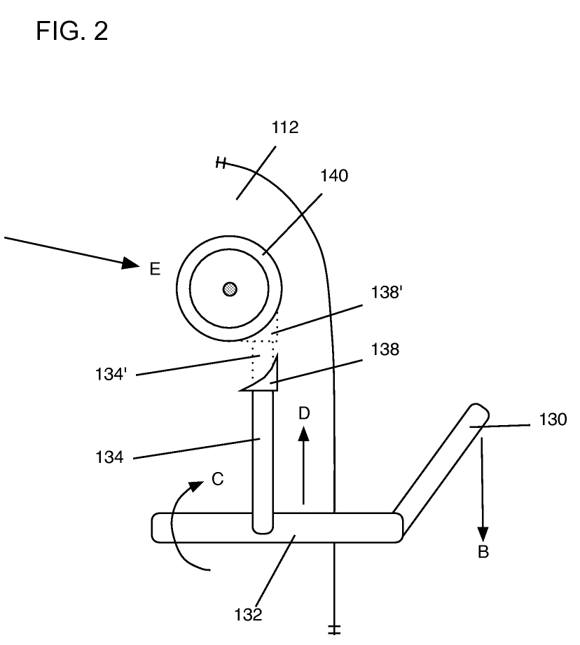

FIG. 2 shows a detailed view of the braking mechanism of FIG. 1D. Upon the downward movement of brake arm 130 along path B, a rotational movement along path C is imparted to brake shaft 132. A corresponding upward movement along path D is imparted to brake rod 134. An analogous downward movement would be imparted to brake rod 136 (FIG. 1D), which is attached to a surface of brake shaft 132 opposite that of brake rod 134. Movement of brake rod 134 along path D sends brake rod 134 toward wheeled member 140 to position 134′ (shown in phantom). As shown in FIG. 2, brake rod 134 is fitted with a brake shoe 138 shaped to correspond to the shape of wheeled member 140. Upon movement of brake rod 134 along path D, brake shoe 138 moves to position 138′, contacting wheeled member 140, preventing or impeding its movement. As will be recognized by one skilled in the art, the braking mechanism of FIG. 2 is merely illustrative of the braking mechanisms that may be employed and is in no way intended to limit the scope of the invention. For example, brake rod 134 may be adapted to fit within a corresponding slot (not shown) within a track (described below), thereby preventing the descent of rescue chair 100 (FIGS. 1A-D).

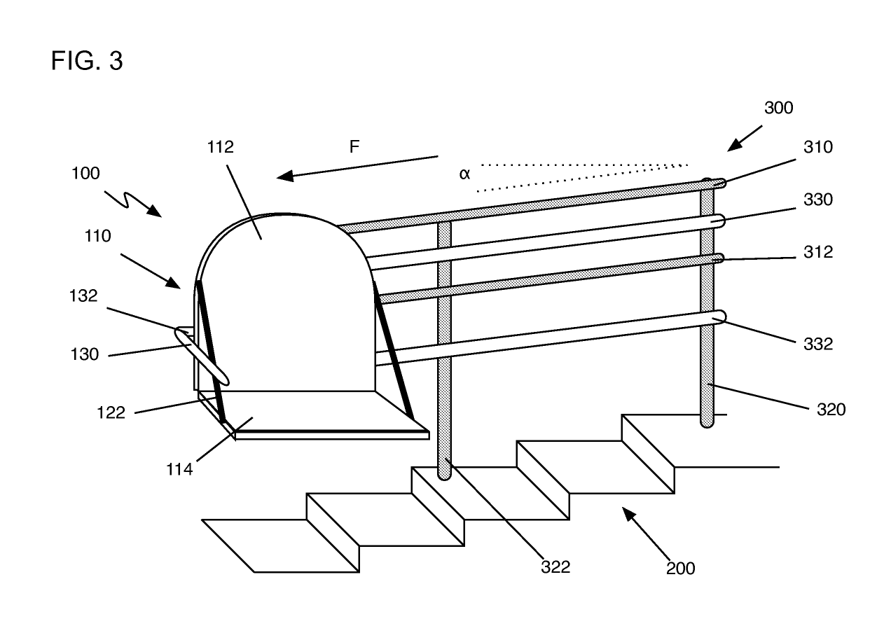

Referring now to FIG. 3, a rescue chair 100 according to the invention is shown in conjunction with a pair of track members 330, 332 secured to a railing 300 adjacent a flight of stairs 200. Railing 300 includes angled handrails 310, 312 supported by a plurality of vertical columns 320, 322. Handrails 310, 312 are angled (i.e., angle α) relative to horizontal in order to follow the descent of the flight of stairs 200. As will be described in greater detail below, a pair of track members 330, 332 vertically disposed relative to each other, as shown in FIG. 3, is preferred in practicing the invention. Other configurations and arrangements are possible, however, as will be recognized by one skilled in the art.

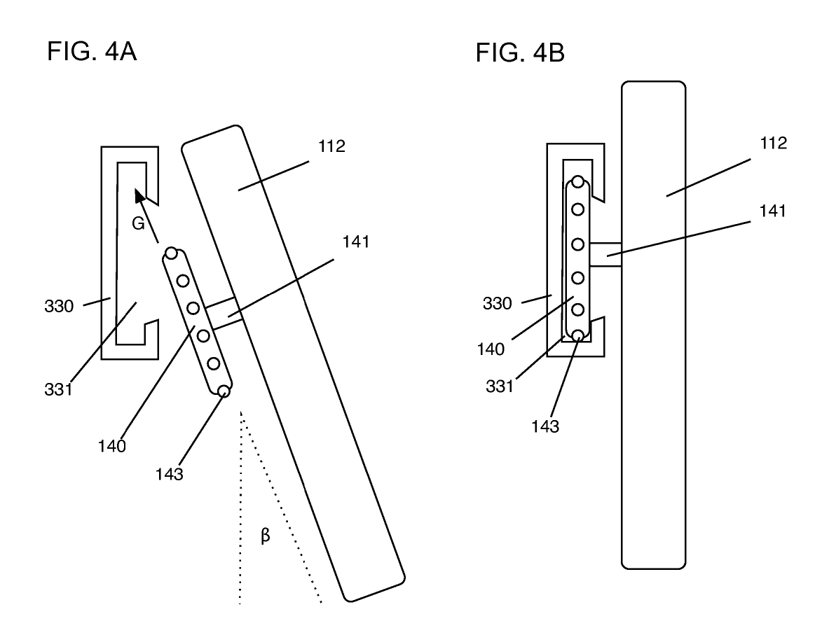

FIGS. 4A-B show cross-sectional views of the placement of a wheeled member 140 into track member 330. In FIG. 4A, back portion 112 is angled (i.e., angle β) relative to vertical and moved along path G, such that wheeled member 140 passes into slot 331 of track member 330. Once wheeled member 140 is inserted fully into slot 331, back portion 112 is moved to the substantially vertical orientation of FIG. 4B, such that wheeled member 140 rests against and within track member 330. The connection of wheeled member 140 and track member 330 in the manner shown in FIGS. 4A-B prevents the accidental removal of wheeled member 140 from track member 330. That is, in order to remove wheeled member 140, and therefore rescue chair (not shown), from track member 330, one must lift back portion 112 upward and then return it to an angled position, such as that shown in FIG. 4A. Doing so would be difficult or impossible once an individual is sitting within the rescue chair.

The function of wheeled member 140 within track member 330 will be recognized by one skilled in the art. Due to the angle of track member 330, such as that shown in FIG. 3, wheeled member 140 will turn about post 141 and the rescue chair 100 allowed to descend along track member 330 using the force of gravity alone. Accordingly, wheeled member 140 may have any number of configurations and be comprised of any number of materials to aid its turning within track member 330. In a preferred embodiment, a surface of wheeled member 140 adapted to contact track member 330 includes a plurality of ball bearings 143, although this is not essential.

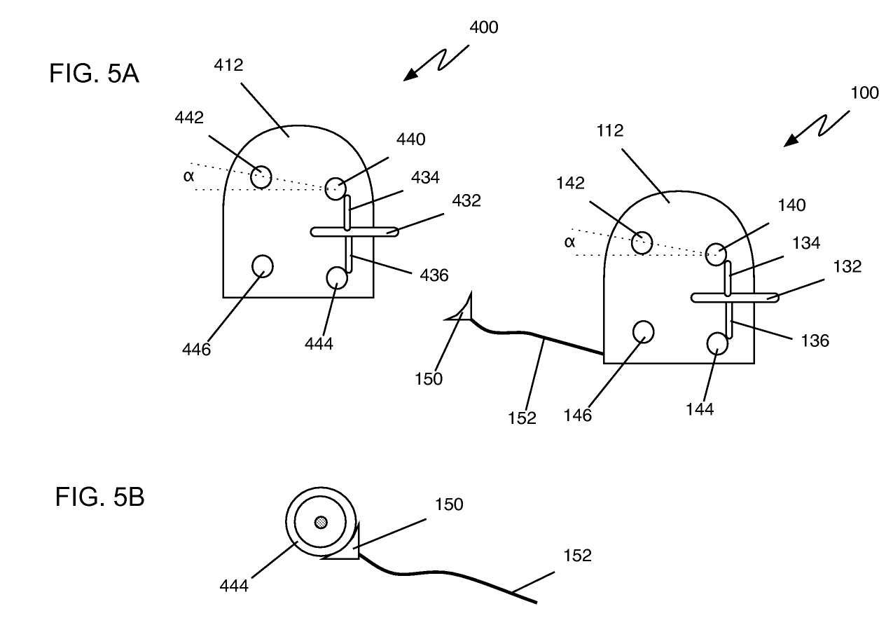

FIGS. 5A-B show an optional safety device for use in the present invention. In FIG. 5A, a rear view of two rescue chairs 100, 400 are shown in their approximate positions along a pair of track members (not shown, for purposes of clarity). As rescue chairs 100, 400 descend along the pair of track members, it is possible that the “uphill” rescue chair, i.e., rescue chair 400, may descend at a rate faster than the “downhill” rescue chair, i.e., rescue chair 100. This may be due to any number of factors, particularly the relative weights of the individuals within each rescue chair. In order to prevent a collision between the uphill rescue chair 400 and the downhill rescue chair 100, a chock 150 or similar device may be attached to the downhill rescue chair 100 by a flexible member 152, such as a cord, and placed within one of the pair of track members. As such, chock 150 trails behind the downhill rescue chair 100 as it descends along the pair of track members.

FIG. 5B shows a detailed view of chock 150 and its interaction with a wheeled member 444 of the uphill rescue chair 400. Preferably, chock 150 is shaped to correspond to a surface of wheeled member 444, although this is not essential. Chock 150 serves to impede the movement of wheeled member 444 (and therefore rescue chair 400, FIG. 5A) along the track member, thereby preventing the uphill rescue chair 400 (FIG. 5A) from colliding with the downhill rescue chair 100 (FIG. 5A).

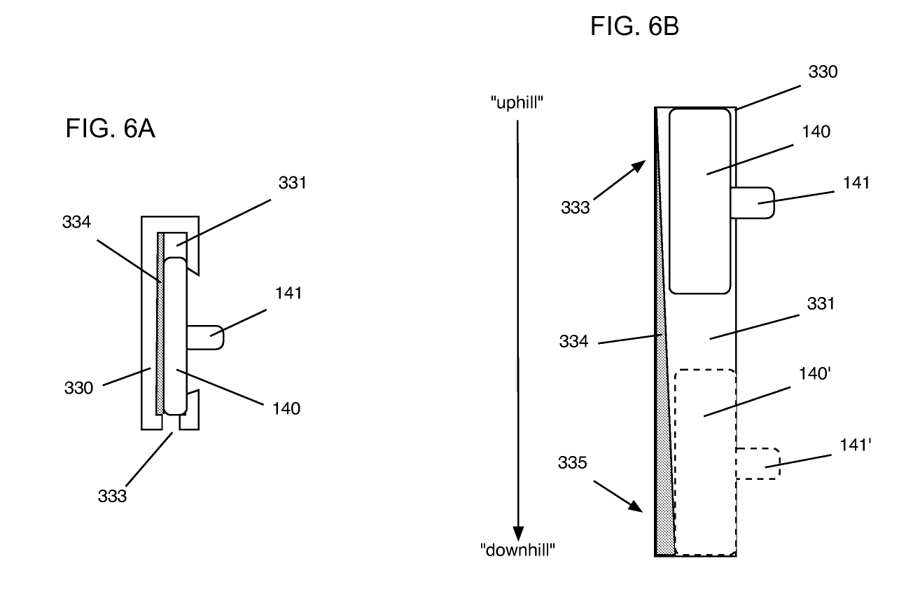

Referring now to FIGS. 6A-B, side and top cross-sectional views of track member 330, respectively, are shown. FIGS. 6A-B show a friction member 334 within slot 331 of track member 330. Friction member 334 is adapted to contact wheeled member 140 along a portion of track member 330, thereby slowing or, optionally, stopping the descent of wheeled member 140, and therefore rescue chair 100 (FIG. 5A), along track member 330. In addition, track member 330 may, at periodic points along its length, include one or more slots 333, through which a lock mechanism, chock, or similar device may be inserted in order to prevent movement of rescue chair 100 along track member 330. Slot 333 may be particularly useful along horizontal portions of track member 330, such as at a stairway landing, where users may enter and exit rescue chair 100.

FIG. 6B shows a top cross-sectional view of FIG. 6A. As can be seen in FIG. 6B, friction member 334 may optionally be wedge-shaped, with a thinner portion 333 oriented in an “uphill” direction and a thicker portion 335 oriented in a “downhill” direction. As such, the friction imparted to wheeled member 140 by friction member 334 increases as wheeled member 140 descends to a downhill position 140′. That is, the wedge-shape of friction member 334 results in an increasing deceleration of wheeled member 140, and therefore rescue chair 100 (FIG. 5A), as wheeled member 140 moves along track member 330.

Friction member 334 may be employed, for example, toward the bottom of a stairway, where it may be desirable to slow the descent of rescue chair 100 (FIG. 5A) before it reaches an end of track member 330. Friction member 334 may also be employed as track member 330 approaches a stairway landing (not shown), in the case that the stairway comprises more than one flight of stairs separated by a landing, as would commonly be found in buildings having more than two stories. That is, as rescue chair 100 descended along track member 330 toward the stairway landing, friction member 334 would act to slow the descent of rescue chair 100 as track member 330 turned at the stairway landing and began another descent down the lower stairway.

As noted above, in a building comprising more than two stories, a stairwell may comprise two or more stairways separated by one or more stairway landings. In such a case, the angled orientation of a pair of wheeled members (e.g., 140, 142 in FIG. 1D) may need to be adjustable in order to avoid seat portion 114 (FIGS. 1A-C) of rescue chair 100 (FIGS. 1A-D) tilting from a substantially horizontal orientation as the rescue chair 100 moves to a horizontal portion (not shown) of track member 330 adjacent the stairway landing.

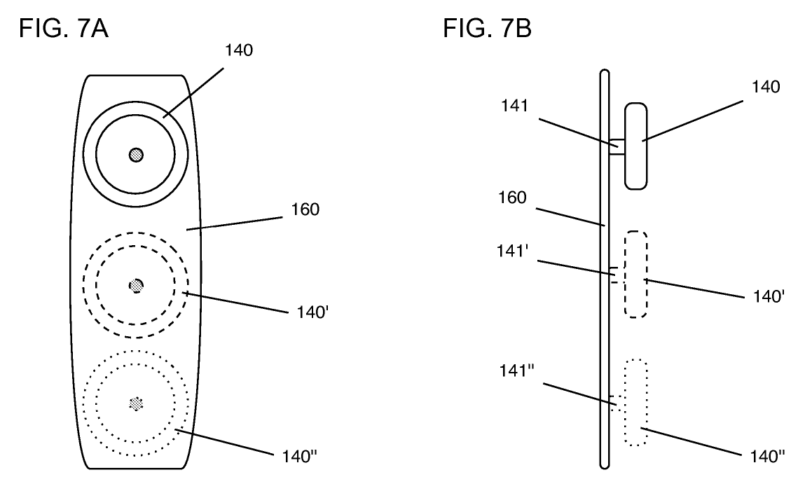

In such a case, rescue chair 100 may include an adjustable track 160, as shown in FIGS. 7A-B, in which a wheeled member 140 is seated. FIGS. 7A-B show a rear view and a side view, respectively, of adjustable track 160 and the alternative positions of wheeled member 140. Preferably, one or both of a pair of wheeled members (e.g., 140, 142 in FIG. 1D) are seated in such an adjustable track 160. Adjustable track 160 includes a mechanism for moving wheeled member 140 to one or more alternative positions, i.e., 140′, 140″. As will be recognized by one skilled in the art, any number of mechanisms may be employed to move wheeled member 140 to its alternative positions 140′, 144″, including, for example, a universal joint. In a preferred embodiment, the mechanism includes a ratcheting mechanism.

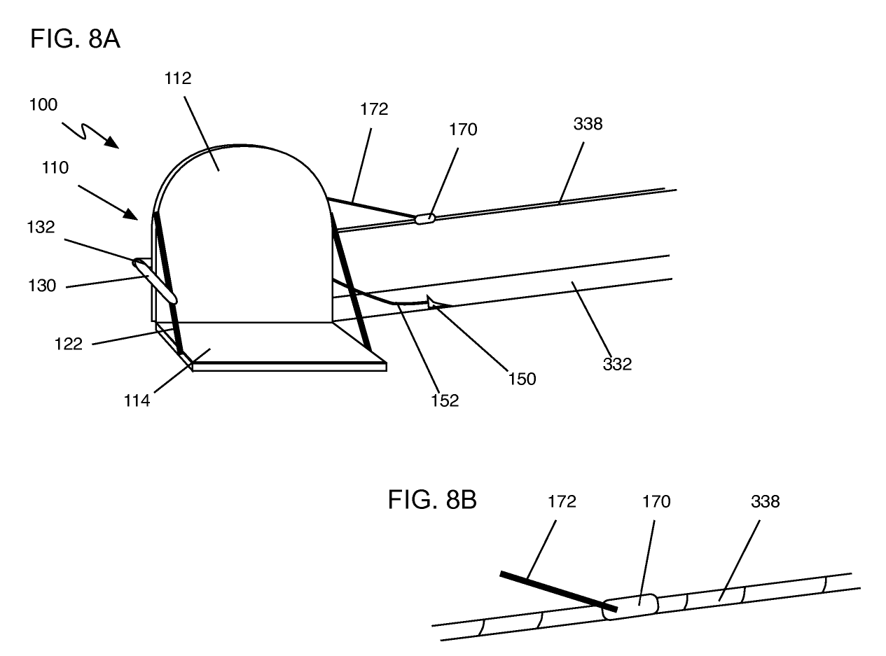

Referring now to FIGS. 8A-B, one or both pairs of wheeled members (e.g., 140, 142 and 144, 146 in FIG. 1D) may be replaced with a clamp member 170 adapted to attach to and follow a cable 338 located adjacent a stairway 200 (FIG. 3). As shown in FIG. 8A, the top pair of wheeled members has been replaced with a clamp member 170 connected to rescue chair 100 by a cord 172 or similar elongate member, while the bottom pair of wheeled members (not shown) has been retained and sit within track member 332. Clamp member 170 may comprise any number of devices known in the art, including, for example, clamp devices such as those used to secure window washing platforms. In a preferred embodiment, clamp member 170 includes a speed-regulating mechanism to control the descent of rescue chair 100.

FIG. 8B shows a detailed view of clamp member 170 attached to cable 338. As will be recognized by one skilled in the art, clamp member 170 may be adapted to limit the rate at which it, and therefore rescue chair 100, descends along cable 338. That is, clamp member 170 may incorporate a brake member or mechanism.

As described above, the device and system of the present invention provide numerous advantages over known devices and systems. The simplicity and ease of storage of devices and systems of the present invention provide greater flexibility in their use. For example, a number of rescue chairs according to the invention may easily be folded and stored at a landing of a stairwell without obstructing use of the stairwell in non-emergency situations.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A gravity-powered device for transporting an individual down a flight of stairs comprising:
a seat member adapted to support an individual;
at least one wheeled member adapted to follow a track adjacent a flight of stairs; and
a brake member adapted to control a rate of descent of the device along the track,
wherein the device is operable to descend the flight of stairs using the force of gravity.

2. The device of claim 1, wherein the seat member is foldable.

3. The device of claim 1, wherein a surface of the at least one wheeled member includes a plurality of ball bearings, the ball bearings being adapted to contact an inner surface of the track.

4. The device of claim 1, further comprising:
an anti-collision member adapted to follow the device as the device descends along the track, thereby preventing a collision between the device and a following device.

5. The device of claim 1, wherein the at least one wheeled member is connected to the seat member.

6. The device of claim 5, wherein the device includes at least two wheeled members disposed at an angle to each other relative to a horizontal portion of the seat member.

7. The device of claim 6, wherein a vertical position of at least one of the at least two wheeled members is alterable.

8. The device of claim 1, wherein the at least one wheeled member is adapted to be removable from the track.

9. A gravity-powered device for transporting an individual down a flight of stairs comprising:
a seat member adapted to support an individual;
at least one clamp member adapted to follow a cable adjacent a flight of stairs; and
a brake member adapted to control a rate of descent of the device along the track,
wherein the device is operable to descend the flight of stairs using the force of gravity.

10. The device of claim 9, wherein the seat member is foldable.

11. The device of claim 9, wherein the at least one clamp member includes the brake member.

12. The device of claim 9, further comprising:
an anti-collision member adapted to follow the device as the device descends along the cable, thereby preventing a collision between the device and a following device.

13. The device of claim 9, wherein the at least one clamp member is removable from the cable.

14. A gravity-powered system for transporting an individual down a flight of stairs comprising:
at least one seat member adapted to support an individual;
means for directing the at least one seat member along a path adjacent a flight of stairs; and
a brake member for controlling a rate of descent of the at least one seat member along the path,
wherein the at least one seat member is operable to descend the flight of stairs using the force of gravity.

15. The system of claim 14, wherein the at least one seat member is foldable.

16. The system of claim 14, wherein the means for directing the at least one seat member is selected from a group consisting of: a track adapted to accept at least one wheeled member of the at least one seat member and a cable adapted to support a clamp member secured to the at least one seat member.

17. The system of claim 16, wherein a surface of the at least one wheeled member includes a plurality of ball bearings.

18. The system of claim 16, wherein the at least one clamp member includes the brake member.

19. The system of claim 16, wherein the at least one wheeled member is adapted to be removable from the track.

20. The system of claim 14, further comprising:
a block member adapted to follow a first seat member as the first seat member descends along the path, thereby preventing a collision between the first seat member and a following second seat member.
